(19) United States
(12) Patent Application Publication
(10) Pub. No.: US 2026/0219485 A1
(43) Pub. Date: Jul. 30, 2026

(54) METHOD FOR SCANNING AN AREA WITH A MULTI-PHOTON LASER SCANNING MICROSCOPE AND SUCH MULTI-PHOTON LASER SCANNING MICROSCOPE

(71) Applicant: FEMTONICS KFT., Budapest (HU)

(72) Inventors: András FEHÉR, Budapest (HU); József Balázs RÓZSA, Budapest (HU); Gergely SZALAY, Budapest (HU); Katalin ÓCSAI, Budapest (HU); Gergely KATONA, Budapest (HU); Máté VERESS, Budapest (HU); Pál MAÁK, Budapest (HU); János ORBÁN, Kerepes (HU); Péter PATAI, Budapest (HU)

(73) Assignee: FEMTONICS KFT., Budapest (HU)

(21) Appl. No.: 19/140,961

(22) PCT Filed: Dec. 18, 2023
(86) PCT No.: PCT/HU2023/050092

§ 371 Date: Jun. 18, 2025

(30) Foreign Application Priority Data
Dec. 22, 2022 (HU) P2300026

(51) Int. Cl. G02B 21/00; G01N 21/64; G02F 1/33

(52) U.S. Cl. CPC G02B 21/0032; G01N 21/6458; G02B 21/0036; G02B 21/0076; G02F 1/33; G01N 2021/6463; G01N 2201/06113

(57) ABSTRACT

The invention relates to a method for scanning an area with a multi-photon laser scanning microscope containing acousto-optical deflectors. The method according to the invention comprises scanning the area of a disc lying in an X-Y plane perpendicular to an optical axis of the microscope's objective by applying frequency drive signals to the deflectors, the drive signals having a first term targeting a centre of the disc, and having a second term for scanning a periphery of the disc. The invention further relates to a multi-photon laser scanning microscope containing a drive system configured to perform this method.

The invention relates to a method of scanning an area with a multi-photon laser scanning microscope.

The invention further relates to such a laser scanning microscope.

Scanning methods, in particular 3-dimensional laser scanning methods play a great role in examining biological samples, which involve, among others, mapping the structure of the biological sample, the distribution of fluorescent markers, or the surface receptors of the cells.

Known scanning procedures generally use 3-dimensional laser scanning microscopes, which are now predominantly multi-photon (typically two-photon) microscopes.

Multi-photon laser scanning microscopes work with laser light of lower photon energy but higher intensity, from which the simultaneous absorption of several, typically two photons, is required to excite a fluorophore. The emitted fluorescence photon can be detected with a detector. The same scanning is also suitable for manipulating the sample, for example photostimulation and activation.

With the aforementioned technology, 3-dimensional scanning can be achieved by moving the stage with stepper motors, although this method is rarely used in practice due to its slowness and mechanical uncertainty. During the examination of biological samples, the focal point of the laser beam is moved instead of the sample in such a way that the laser beam is deflected and focused on the desired location.

There are several known technologies for deflecting the laser beam. Deflecting mirrors mounted on galvanometric scanners were previously used as deflecting elements, and the depth of the focal plane was controlled by moving the objective along the Z axis, however, this is also considered slow if distant regions within the sample have to be scanned almost simultaneously, for example in nerve impulse transmission measurements.

One of the fastest known technology for deflecting the laser beam is the use of acousto-optical deflectors. WO 2006/042130 A2 describes a solution in which two pairs of acousto-optical (AO) deflectors are used to focus the laser beam of a laser scanning microscope to an arbitrary stationary point within an octahedral spatial region. The first pair of AO deflectors deflects the focal point in the X-Z plane defined by the optical Z axis and an X axis perpendicular to it, while the second AO deflector pair deflects the focal point in the Y-Z plane defined by the Z axis and a Y axis perpendicular to the Z and X axes. The deflectors actually deflect the laser beam, and make it converging or diverging such that the focusing lens system following the deflectors (typically a microscope objective) forms the focal point, therefore the effect of the deflectors manifests in a change in the position of the focal point. AO deflectors contain an AO crystal and a transducer attached to an end of the AO crystal. The transducer converts the electric drive signal into a mechanical signal, which creates an acoustic wave in the AO crystal. In this way, the transducer excites acoustic waves in the AO crystal with a frequency corresponding to the frequency of the electric drive signal. The electric drive signal is usually called a frequency drive signal or frequency signal for short, because the instantaneous frequency of the electric drive signal determines the frequency of the acoustic wave that the transducer excites in the AO crystal. The excited acoustic wave travels (propagates) along the longitudinal axis of the AO crystal in the direction of the end opposite the transducer. As a result of the acoustic wave propagating in the AO crystal, the refractive index of the material changes spatially according to the frequency of the acoustic wave. If the frequency of the frequency drive signal changes over time, this results in the frequency of the acoustic wave also changing along the longitudinal axis of the AO deflector. In this way, the AO crystal behaves as a spatially and temporally changing diffraction grating and is able to deflect the passing laser beam and make it convergent or divergent. In the above-mentioned patent document WO 2006/042130 A2, a transducer is located at the opposite ends of the members of the AO deflector pairs, thus creating an acoustic wave propagating in the opposite direction within the members of the AO deflector pairs. To create a stationary focus spot, a frequency drive signal with a constant slope (commonly known as frequency chirp signal, chirp signal for short) is applied to the members of the AO deflector pairs, i.e. to the transducers forming part of the AO deflectors, thus creating counter-propagating acoustic waves with a constant frequency gradient. The possible spatial position of the focal spot is limited by the bandwidth of the AO deflectors (more precisely of the transducers forming part of them), within which the frequency of the chirp signal can change, resulting in the octahedron-shaped scannable region presented in the patent document, within which a stationary focal spot can be created at any point by appropriate settings of the chirp signals.

Other deflector arrangements are also known as compared to the one described in the above patent document. For example, according to WO 2008/032061 A2, the deflectors deflecting in the X-Z and Y-Z planes are arranged alternately, so the deflector deflecting in one plane is always followed by the deflector deflecting in the other plane, and between adjacent deflectors, a telecentric relay (afocal telescope) images the previous deflector to the next deflector.

In the arrangement disclosed in WO2010/076579A1 the deflectors deflecting in the X-Z plane are arranged between the deflectors deflecting in the Y-Z plane, thus a single common telecentric relay between the two deflectors deflecting in the X-Z plane and the two deflectors deflecting in the Y-Z plane can ensure the imaging. Due to the negative (typically −1) lateral magnification of the telecentric relay, the transducers are located at the same ends of the deflectors deflecting in the same plane, and the excited acoustic waves travel in the same direction relative to each other.

The prior art mode of laser scanning microscopes, in which AO deflector pairs are used to create a stationary focal spot with the help of frequency chirp signals driving the deflectors, is called random access point scanning mode. As can be seen from the references above, this can be achieved in known ways using different arrangements of the AO deflectors.

In random access point scanning mode, stationary focus spots are used to scan a sample in such a way that the 2- or 3-dimensional range of the sample to be examined is scanned point by point with the successively created discrete focal points. Although acousto-optical deflectors are very fast devices, with the help of which the focus spot can be created very quickly (in as little as 10-20 microseconds) in the desired stationary position, scanning is still a time-consuming process if the area to be scanned needs to be covered with a series of stationary points. In order to be able to focus the laser beam into consecutive stationary points, chirp signals corresponding to the given stationary point must be applied to the AO deflectors. when changing between two consecutive chirp signals used to target different locations, the focus spot in one stationary point disintegrates, while the new focus spot gradually appears in the other. For some time during the transition, none of the focal spots are of sufficient intensity and size to generate well-detectable fluorescence excitation.

Several solutions have been developed to solve this problem.

WO2020/035710A1 describes a solution in which several acoustic wave parts are created in a single AO crystal by concatenating several chirp signals, which are simultaneously focused at different points, thus the AO deflector can measure at several points at the same time.

In the already mentioned patent document WO 2008/032061 A2, instead of producing a stationary focal spot, the focal spot is continuously moved along a straight line lying in the focal plane by controlling the frequency difference between the acoustic waves created in the AO deflectors.

EP2800995 B1, as well as patent application WO 2018/042214 A2, and paper “Fast 3D Imaging of Spine, Dendritic, and Neuron Assemblies in Behaving Animals” (Szalay et al., 2016, Neuron 92, 37-72 in article 372) all disclose scanning systems, in which the focal spot is not focused to a stationary point, but moves continuously (drifting) with the help of four consecutive AO deflectors. The focal spot was moved in the X-Y plane by controlling the frequency difference of the acoustic waves created in the deflectors, while the axial position of the focal point along the Z axis was changed by controlling the slope of the chirp signals produced in the deflectors. From here on this will be referred to as drift mode.

Continuous scanning of special lines is also known from the prior art.

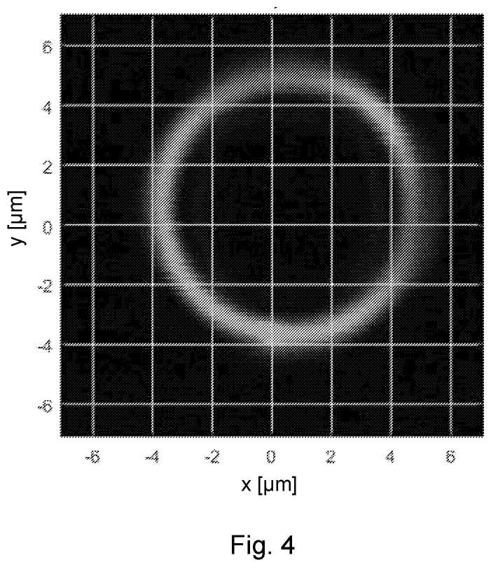

In the paper “Acousto-optic scanning system with very fast nonlinear scans” (Friedman et al. OPTICS LETTERS/Vol. 25, No. 24/Dec. 15, 2000) the scanning of a circular arc lying in the X-Y plane was described. The paper aims to demonstrate how aberrations can be reduced during fast scanning by using a pair of AO deflectors filled with counter-propagating acoustic waves instead of a single AO deflector deflecting in each plane. The results are presented in connection with continuous scanning along a circular arc. Although the paper talks about “very fast” scanning, this is only very fast compared to scanning with a single AO deflector instead of two pairs of AO deflectors. Compared to the T_{access} filling time of the AO deflectors, i.e. the time required for the acoustic wave to fill the aperture corresponding to the width of the optical beam passing through the AO deflector, the scanning speed cannot be considered fast at all, since the T_{scan} period of scanning a whole circle in the measurements presented in the paper is an order of magnitude greater than the T_{access} filling time. The T_{access} filling time was 0.62 μs in the measurements, while the T_{scan} period calculated from the highest scanning frequency shown in FIG. 4 was 5 μs, which is almost ten times greater than the T_{access} filling time. The authors did not recommend scanning faster than this, nor did they examine it, as they were looking for the answer at which speed the focal spot does not spread out or fall apart. The latter phenomenon was considered undesirable.

In the paper “Acousto-optic lens with very fast focus scanning” (Kaplan et al. OPTICS LETTERS/Vol. 26, No. 14/Jul. 15, 2001) a system consisting of two acousto-optic deflectors is presented, with the help of which the focus spot can be moved harmoniously along the Z axis corresponding to the optical axis. Here, the authors specifically pointed out that proper focusing can only be achieved in the case of T_{scan}>>T_{access}.

In biological measurements, simultaneous scanning of cell populations is often necessary. This is usually solved with random access point scanning mode by creating a stationary focal spot at the centre of each cell one after the other, thus measuring the centre of the cell. This has several disadvantages. On the one hand, the signal to be measured is not necessarily the strongest in the centre of the cell. On the other hand, in case of a live sample (for in vivo measurements), the cell may move, so that the focal spot is no longer at the centre of the cell, but at its edge, or even outside of the cell. The above-mentioned patent application WO 2018/042214 A2 and the paper “Fast 3D Imaging of Spine, Dendritic, and Neuronal Assemblies in Behaving Animals” (Szalay et al., 2016, Neuron 92, 723-738) offers a solution to these problems and recommends, among other things, to scan squares in the X-Y plane covering the biological objects to be examined (e.g. soma, dendritic spines), such that the squares are made up of short parallel lines along which the focal spot is continuously moved in drift mode. When quasi-simultaneous measurement of a large number of objects is required, even this method is not fast enough. For example, a 20 μm×20 μm area with a focal spot size of 0.5-1 micron can be scanned with 20 mini drifts, which requires 20 AO cycles. A typical AO cycle time is 30 μsec (for an incident beam diameter of 15 mm), so 20 cycles take 20×30 μsec.

The object of the invention is to provide a scanning method with which it is possible to scan small areas (typically areas smaller than 20 μm×20 μm) in planes perpendicular to the optical axis of a laser scanning microscope with the help of AO deflectors significantly faster than it would be possible with the prior art methods.

Another object of the invention is to provide such a laser scanning microscope.

The inventors of the invention realized that in the case of scanning along a circle or an ellipse, if the scanning speed is substantially increased with respect to what is proposed in the aforementioned paper “Acousto-optic scanning system with very fast nonlinear scans” (Friedman et al. OPTICS LETTERS/Vol. 25, No. 24/Dec. 15, 2000), then the phenomenon of aberration occurrence, previously considered undesirable, can be used in an unexpected way to scan the entire area within the circle or ellipse. The inventors of the present invention have found that when the period T of scanning along the circle or ellipse (corresponding to the T_{scan} time of the above article) is reduced to the order of magnitude of the filling time T_{acc} of the AO deflectors (corresponding to the T_{access} time of the above article), then the occurring aberrations result in satellite spots towards the centre of the circle or ellipse, the intensity of which is sufficiently high that it is possible to collect information from inside the circle or ellipse, that is, to scan by multi-photon or two-photon excitation.

Accordingly, the invention relates to a method of scanning an area with a multi-photon laser scanning microscope comprising at least one laser source and a focusing lens system defining an optical Z axis. An optical beam path is provided between the at least one laser source and the focusing lens system. The microscope further comprises first and second acousto-optical deflectors arranged in the optical beam path for deflecting a laser beam exiting the focusing lens system in an X-Z plane defined by the optical Z axis and an X axis perpendicular to the optical Z axis, and third and fourth acousto-optical deflectors arranged in the optical beam path for deflecting the laser beam exiting the focusing lens system in an Y-Z plane defined by the optical Z axis and an Y axis perpendicular to the optical Z axis and the X axis.

The invention is characterised by scanning a disk lying in a plane perpendicular to an X-Y plane defined by the X axis and the Y axis by guiding the laser beam along the optical beam path from the laser source to the focusing lens system while providing frequency drive signal functions ƒ_{X1}(t), ƒ_{X2}(t), ƒ_{Y1}(t), ƒ_{Y2}(t) to the first, second, third and fourth acousto-optical deflectors defined by equations

$${f}_{X 1} ( t ) = {f}_{0 X 1} ( t ) + Δ {f}_{X 1} ( t )$$

$${f}_{X 2} ( t ) = {f}_{0 X 2} ( t ) + Δ {f}_{X 2} ( t )$$

$${f}_{Y 1} ( t ) = {f}_{0 Y 1} ( t ) + Δ {f}_{Y 1} ( t )$$

$${f}_{Y 2} ( t ) = {f}_{0 Y 2} ( t ) + Δ {f}_{Y 2} ( t )$$

respectively, wherein ƒ_{0X1}(t), ƒ_{0X2}(t), ƒ_{0Y1}(t), ƒ_{0Y2}(t) are frequency drive signal terms for focusing the laser beam in random access point scanning mode to a centre of the disk, the centre having coordinates x, y, z, and Δƒ_{X1}(t), Δƒ_{X2}(t), Δƒ_{Y1}(t), Δƒ_{Y2}(t) are frequency drive signal terms determining a periphery of the disc and being defined by equations

$$Δ {f}_{X 1} ( t ) = {s}_{X 1} \cdot {f}_{a m p X} \cdot cos ( \frac{2 π}{T} t + φ ) ,$$

$$Δ {f}_{X 2} ( t ) = {s}_{X 2} \cdot {f}_{a m p X} \cdot cos ( \frac{2 π}{T} t + φ ) ,$$

$$Δ {f}_{Y 1} ( t ) = {s}_{Y 1} \cdot {f}_{a m p Y} \cdot sin ( \frac{2 π}{T} t + φ ) ,$$

$$Δ {f}_{Y 2} ( t ) = {s}_{Y 2} \cdot {f}_{a m p Y} \cdot sin ( \frac{2 π}{T} t + φ ) ,$$

wherein s_{X1}, s_{X2}, s_{Y1}, s_{Y2} are selected from values +1 and −1, ƒ_{ampX} is a first multiplying factor determining a first radius R_{X} of the disc along the X axis, ƒ_{ampY} is a second multiplying factor determining a second radius R_{Y} of the disc along the Y axis, φ is an arbitrary phase shift, and T is a time period required for scanning the disc and selecting a value of the time period T such as to fall between 0.25·T_{acc} and 1.6·T_{acc}, wherein T_{acc} is a filling time of the deflectors.

The method according to the invention works in any plane with an arbitrary z coordinate, therefore also in the z=0 plane, which is included in the above wording, since the X-Y plane defined by the X axis and Y axis is also parallel to itself, therefore the above wording also includes the possibility of scanning a disc lying in the X-Y plane defined by the X axis and Y axis, whereby the z coordinate of the centre of the disc is 0.

It is well known to a person skilled in the art how to choose the terms ƒ_{0X1}(t), ƒ_{0X2}(t), ƒ_{0Y1}(t), ƒ_{0Y2}(t) so that in absence of the terms Δƒ_{X1}(t), Δƒ_{X2}(t), Δƒ_{Y1}(t), Δƒ_{Y2}(t) the four deflectors create a stationary focus spot at the location with coordinates x, y, z corresponding to the centre of the disk (this corresponds to the random access point scanning mode). The description of the state-of-the-art lists, among others, such documents, the contents of which are hereby incorporated by reference.

The frequency drive signal components Δƒ_{X1}(t), Δƒ_{X2}(t), Δƒ_{Y1}(t), Δƒ_{Y2}(t) determining the circumference of the disc were given as cosine modulation in the first and second deflectors, while in the third and fourth deflectors as sine modulation, however it is clear that this is equivalent to the case where sine modulation is used in the first and second deflectors, and cosine modulation in the third and fourth deflectors. It is even possible to include a common phase shift φ in the argument of each sine/cosine term, as reflected in the formulas given above. With this phase shift parameter φ, it is possible to control where to start scanning the disk, e.g. at its top, at its right edge, etc. If the phase shift φ is chosen to be 90°, the sines become cosines and vice versa.

The filling time T_{acc} of the deflectors is the effective filling time, the value of which is T_{acc}=H/V wherein H is the diameter of the laser beam entering the acousto-optical deflector if the diameter of the beam is smaller than the aperture of the deflector, and H is the diameter of the aperture of the deflector if the diameter of the aperture is smaller than the beam diameter, and V is the acoustic phase velocity of the acoustic wave in the acousto-optic deflectors. If several different deflectors are used, the filling time T_{acc} of the deflectors means the filling time T_{acc} of the first deflector arranged along the optical beam path.

The optical beam path means a beam path determined by optical elements along which a laser beam propagates from the laser source to the focusing lens system (typically through its rear aperture). Any optical elements can be used to create the optical beam, which can deflect the laser beam or modify the diameter, divergence, polarization, power, etc. of the beam. Such an optical element can be, for example, a mirror (motorized or manually adjusted and fixed), beam splitter, beam combiner, lens, lens system, prism, iris, Faraday isolator, polarizer, polarization rotating or manipulating optical element (e.g. waveplate), acousto-optical deflector, modulator or filter, electro-optical modulator, dichroic mirror, spectral or neutral filter, etc. Each optical element defining the optical beam path is placed in the beam path created by optical elements located upstream of the given optical element and define the next portion of the optical beam path downstream of the given optical element.

The AO deflectors themselves can be understood as optical elements shaping the optical beam path by being placed in the beam path defined by the other optical elements located upstream of the AO deflectors.

It is noted that the laser beam entering the focusing lens system is only the “useful” part of the laser beam exiting from the laser source from the point of scanning, as the original laser beam is reduced by the time it reaches the rear aperture of the focusing lens system for a number of reasons. For example, due to technical reasons, it may be necessary to decouple a part of the laser beam, for example by using a beam splitter. By definition, the beam path of the decoupled laser beam is not part of the optical beam path between the at least one laser source and the focusing lens system.

Another reason why the useful part of the laser beam does not match the laser beam exiting the laser source is that losses also occur during the operation of the AO deflectors. Deflection in AO deflectors works on the diffraction principle, and AO deflectors are normally optimized so that the intensity of the beam belonging to the +1 or −1 diffraction order should be significantly higher compared to the other diffraction orders, so that this diffraction order can be optimally used for scanning. The other diffraction orders (including the non-deflected 0th diffraction order) can be separated by filters operating on the principle of polarization or spatial filtering or by the spatial arrangement of the AO deflectors. By definition, the separated orders do not belong to the “useful” beam from the point of view of scanning. For this reason, the AO deflectors are defined through their effect on the laser beam exiting the focusing lens system, and not through their effect on the beam entering the AO deflectors, since, for example, none of the AO deflectors deflects the part of the beam that exits as the 0th diffraction order. These are considerations that are obvious to a person skilled in the art, which considerations are also used and presented in, for example, the above-referenced papers and patent documents, cf. e.g. WO 2008/032061 A2 and WO 2010/076579 A1.

The value of the parameters s_{X1}, s_{X2}, s_{Y1}, s_{Y2} is +1 or −1, which is chosen according to the direction in which the given deflector deflects in the focal plane of the lens (in the sense that if e.g. the frequency is increased by 1 MHz, how is the focal spot deflected in the XY plane as a result). If for example the first AO deflector (X1) and second AO deflector (X2) deflecting in the X-Z plane change the X coordinate of the focal spot under the objective in the opposite sense in response to an increase of 1 MHz of the frequency of the drive signals driving them, then the signs of s_{X1} and s_{X2} must also be chosen to be opposite, e.g.: s_{X1=1} and s_{X2=-1}, or the other way around, s_{X1=-1} and s_{X2=1}. However, if the deflectors X1 and X2 cause a change with the same sign in the X coordinate of the focal spot in response to the increase of the frequency of the drive signals, the signs of s_{X1} and s_{X2} must be the same as well, e.g.: s_{X1}=s_{X2=1}, or s_{X1}=s_{X2=-1}. It is obvious to a person skilled in the art how the signs must be chosen for the used deflectors in the given arrangement so that the individual deflectors within the deflector pairs move the focal spot in opposite directions in the XY plane.

The period T is chosen such that its value is between 0.5·T_{acc} and 1.5·T_{acc}, preferably between 0.75·T_{acc} and 1.25·T_{acc}.

The disk is a circle or an ellipse depending on whether the radius R_{X} and the radius R_{Y} are the same or different. Preferably, both the radius R_{X} and the radius R_{Y} are between 2 μm and 20 μm, for example between 5 μm and 10 μm.

The value of the multiplying factor ƒ_{ampX} is chosen so that the radius R_{X} has a first value, and selecting the value of the multiplying factor ƒ_{ampY} so that the radius R_{Y} has a second value, wherein the first and second value may be the same (this is the case when the disk is circular).

In case the centre of the disk is at a distance of more than 50 μm from a focal plane of the objective (assuming an objective with an effective focal length of 10 mm), then the disk is scanned in several cycles by scanning different portions of the disk's circumference in each cycle during a middle time window of a cycle time of the given cycle. The middle time window of the cycle time can be understood as the time interval between the first third and the last third of the cycle time. In order for the middle time window of the cycle time to fall on different portions of the disk's circumference, the starting point of the scanning can be shifted along the disk's circumference with an appropriate choice of the phase shift q, as already mentioned above.

The laser scanning microscope is preferably a two-photon microscope.

The invention further relates to the use of the method according to the invention for scanning a soma which is characterised by selecting the centre of the disc having coordinates x, y, z so as to coincide with a centre of the soma, and selecting a value of the multiplying factor ƒ_{ampX} so that a value of the radius R_{X} is equal to a half of the diameter of the soma along the X axis, and selecting a value of the multiplying factor ƒ_{ampY} so that a value of the radius R_{Y} is equal to a half of the diameter of the soma along the Y axis.

The invention further relates to a laser scanning microscope according to claim 11.

Further preferred embodiments of the invention are defined in the dependent claims.

Further details of the invention will be explained by way of examples with reference to the following drawings. In the drawings:

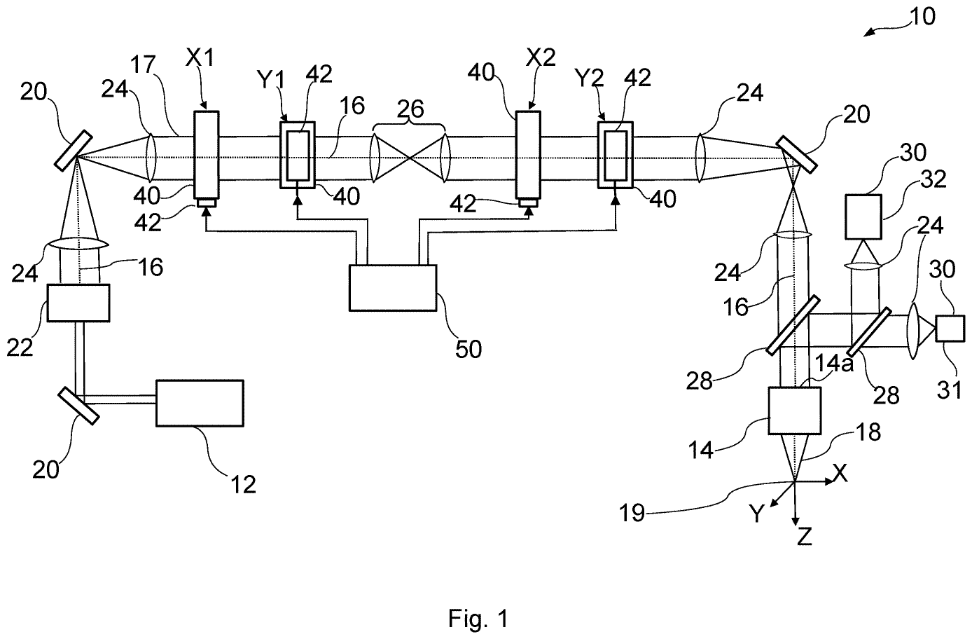

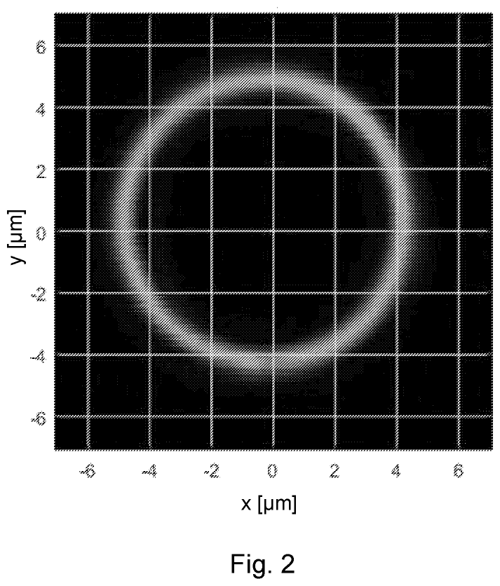

FIG. 1 is a schematic view of an exemplary embodiment of a laser scanning microscope according to the invention,

FIG. 2 is the measurement result of scanning an exemplary disk on fluorescent beads having submicron diameter, wherein the period of scanning the disk is 3 times the filling time of the deflectors (T=3·T_{acc}),

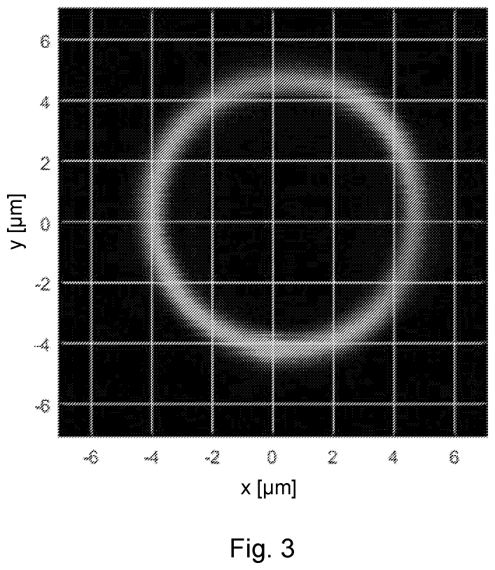

FIG. 3 is the measurement result of scanning the exemplary disk, wherein the period of scanning the disk is 2 times the filling time of the deflectors (T=2. T_{acc}),

FIG. 4 is the measurement result of scanning the exemplary disk, wherein the period of scanning the disk is 1.8 times the filling time of the deflectors (T=1.8. T_{acc}),

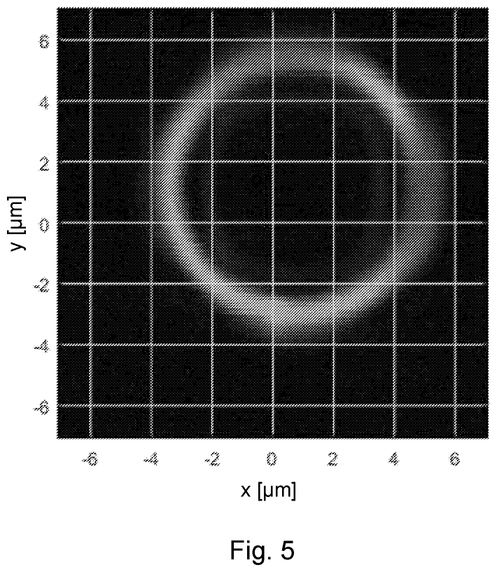

FIG. 5 is the measurement result of scanning the exemplary disk, wherein the period of scanning the disk is 1.6 times the filling time of the deflectors (T=1.6. T_{acc}),

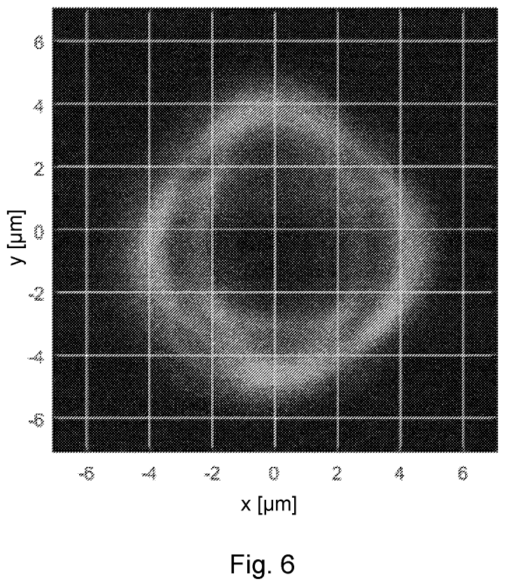

FIG. 6 is the measurement result of scanning the exemplary disk, wherein the period of scanning the disk is 1.4 times the filling time of the deflectors (T=1.4. T_{acc}),

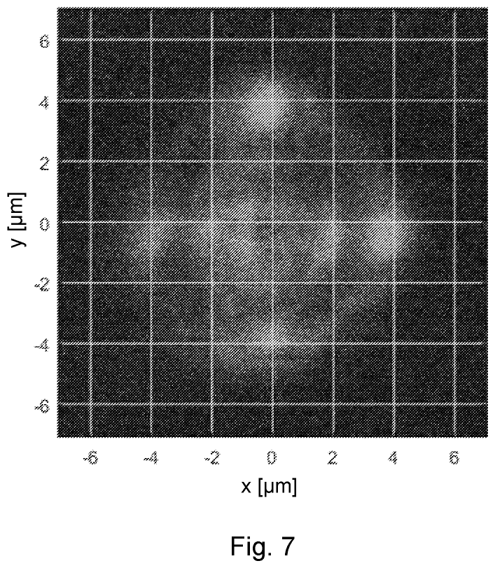

FIG. 7 is the measurement result of scanning the exemplary disk, wherein the period of scanning the disk is the same as the filling time of the deflectors (T=T_{acc}),

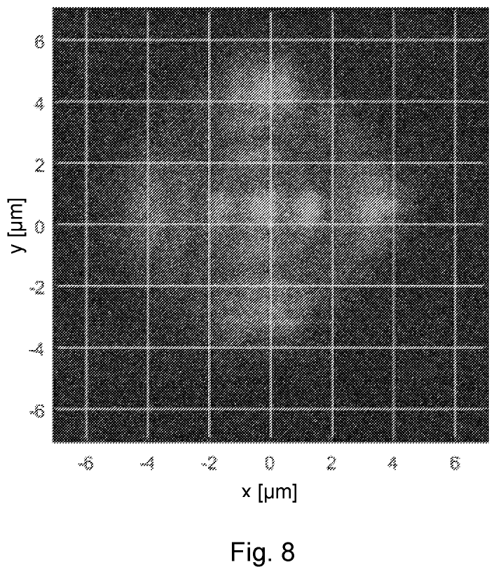

FIG. 8 is the measurement result of scanning the exemplary disk, wherein the period of scanning the disk is 0.75 times the filling time of the deflectors (T=0.75·T_{acc}),

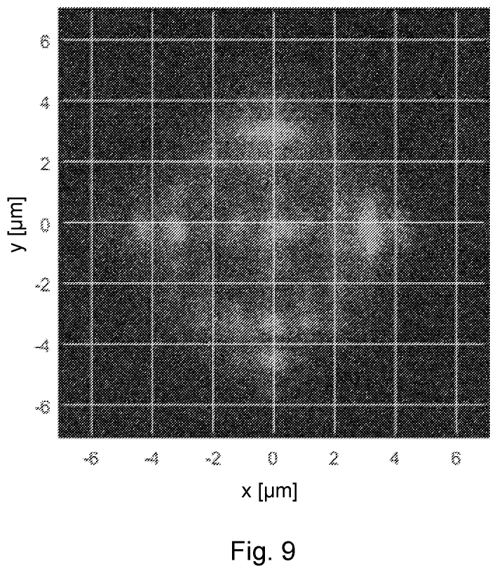

FIG. 9 is the measurement result of scanning the exemplary disk, wherein the period of scanning the disk is 0.5 times the filling time of the deflectors (T=0.5. T_{acc}),

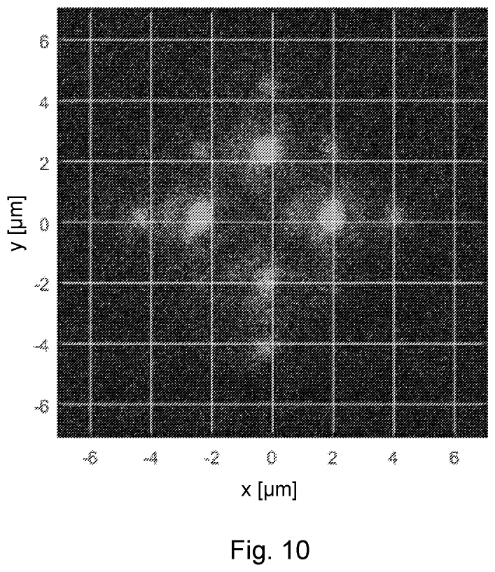

FIG. 10 is the measurement result of scanning the exemplary disk, wherein the period of scanning the disk is 0.25 times the filling time of the deflectors (T=0.25·T_{acc}),

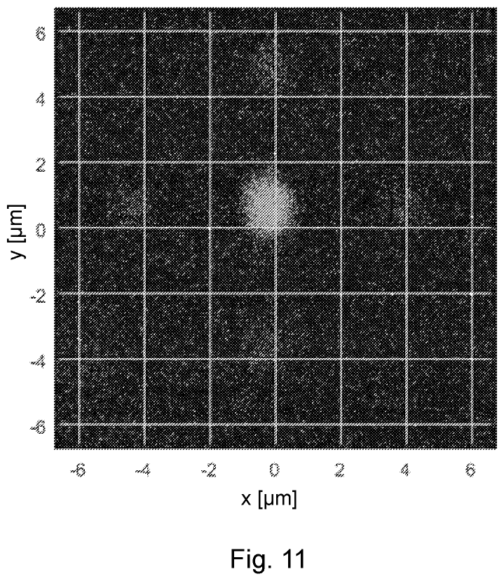

FIG. 11 is the measurement result of scanning the exemplary disk, wherein the period of scanning the disk is 0.125 times the filling time of the deflectors (T=0.125·T_{acc}),

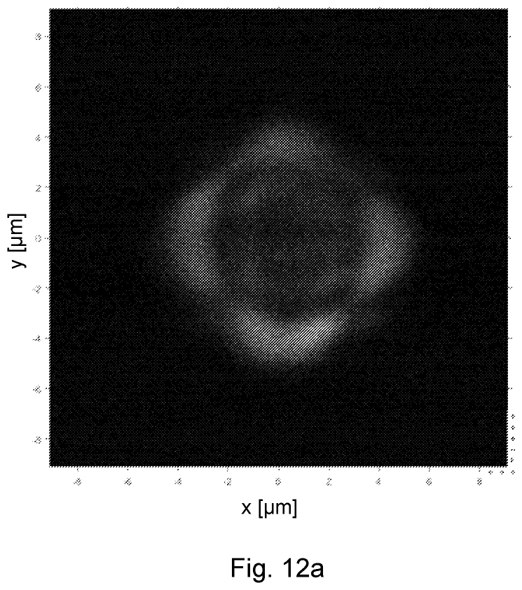

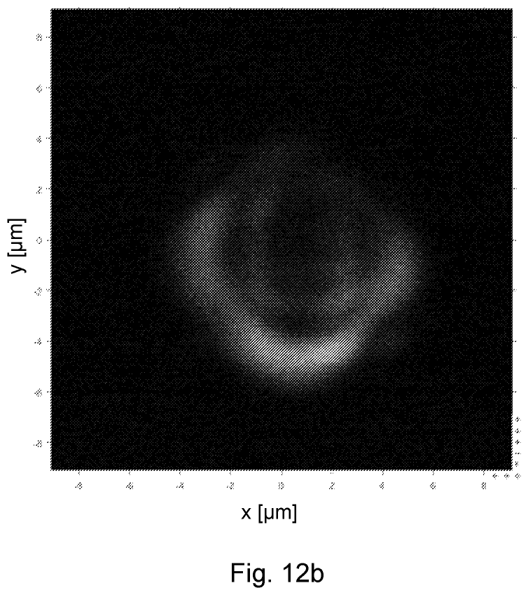

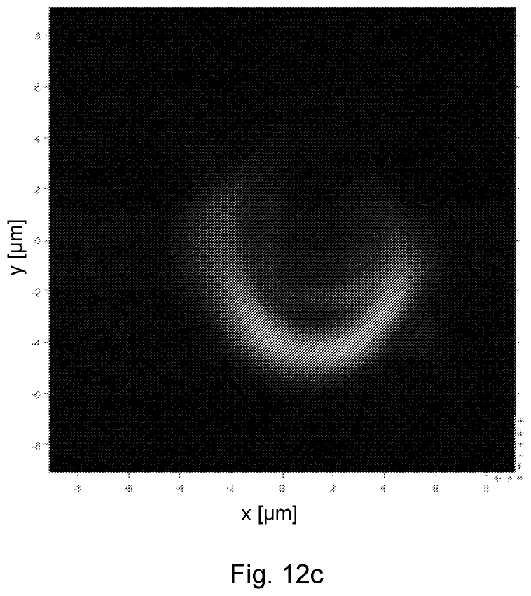

FIGS. 12a-12c show further exemplary scanning of circles, in the case where the centre of the circles does not fall in the focal plane of the objective.

FIG. 1 shows a schematic view of an exemplary embodiment of the two-photon laser scanning microscope 10 according to the invention. In the present embodiment, the microscope 10 is a two-photon microscope with one laser source 12, however, microscopes 10 having several laser sources 12 are also known, with which laser beams of different wavelengths can be produced. The microscope 10 has a focusing lens system defining the optical Z axis, which in this case is a microscope objective 14. Between the laser source 12 and the microscope objective 14, there is an optical beam path, which is indicated by a dashed line in FIG. 1, and which leads from the exit opening of the laser source 12 to the rear aperture 14a of the microscope objective 14. The optical beam path is created by various optical elements, which in the present embodiment are mirrors 20, beam manipulators 22, lenses 24, telecentric relays 26 and beam splitters 28 shown in FIG. 1. The beam manipulator 22 may include, for example, a Faraday isolator, a dispersion compensating module, a beam stabilizer and a beam expander, which are presented separately in, for example, patent document No. WO2016/079547A1 and are also well known from the state of the art. The microscope 10 also comprises one or more detectors 30, in this case a photon multiplier (PMT) detector 31 and a CCD camera 32. The beam splitter 28 is used to direct the fluorescent light emitted by the sample and coming through the objective 14 to the detectors 30. Of course, in addition to these, other known optical elements can also be used to create the beam path 16.

First and second acousto-optical deflectors X1 and X2 are arranged in the optical beam path 16, which are used to deflect the laser beam 18 exiting the objective 14 in the X-Z plane defined by the optical Z axis and an X axis perpendicular to the optical Z axis. In addition, third and fourth acousto-optical deflectors Y1 and Y2 are arranged in the optical beam path 16 for deflecting the laser beam 18 exiting the objective 14 in the Y-Z plane defined by the optical Z axis and an Y axis perpendicular to the optical Z axis and the X axis. The laser beam 18 is focused by the objective 14 into a focal point 19, which in reality is a focal spot, and which is in case of the method according to the present invention, simultaneously a focal spot and several satellite spots.

The X and Y axes are preferably defined in the focal plane of the objective 14, so that the origin of the coordinate system defined by the X, Y and Z axes also lies in the focal plane.

The deflectors X1, X2, Y1, Y2 each contain AO crystals 40 and transducers 42 arranged at one of their ends. In the arrangement shown in FIG. 1, the transducers 42 are located at the same ends of the AO crystals 40 of the deflectors X1 and X2, and at the same ends of the AO crystals 40 of the deflectors Y1 and Y2, whereby the generated acoustic waves propagate in essentially the same direction within the deflectors X1 and X2, and also within the deflectors Y1 and Y2.

The microscope 10 further comprises a drive system 50, which is configured to scan the area of a disk lying in a plane perpendicular to an X-Y plane defined by the X axis and the Y axis by generating frequency drive signal functions ƒ_{X1}(t), ƒ_{X2}(t), ƒ_{Y1}(t), ƒ_{Y2}(t) for the first, second, third and fourth acousto-optical deflectors defined by

$${f}_{X 1} ( t ) = {f}_{0 X 1} ( t ) + Δ {f}_{X 1} ( t )$$

$${f}_{X 2} ( t ) = {f}_{0 X 2} ( t ) + Δ {f}_{X 2} ( t )$$

$${f}_{Y 1} ( t ) = {f}_{0 Y 1} ( t ) + Δ {f}_{Y 1} ( t )$$

$${f}_{Y 2} ( t ) = {f}_{0 Y 2} ( t ) + Δ {f}_{Y 2} ( t )$$

respectively, wherein ƒ_{0X1}(t), ƒ_{0X2}(t), ƒ_{0Y1}(t), ƒ_{0Y2}(t) are frequency drive signal terms for focusing the laser beam in random access point scanning mode to a centre of the disk defined by coordinates x, y, z, and Δƒ_{X1}(t), Δƒ_{X2}(t), Δƒ_{Y1}(t), Δƒ_{Y2}(t) are frequency drive signal terms determining the periphery of the disc and being defined as

$$Δ {f}_{X 1} ( t ) = {s}_{X 1} \cdot {f}_{a m p X} \cdot cos ( \frac{2 π}{T} t + φ ) ,$$

$$Δ {f}_{X 2} ( t ) = {s}_{X 2} \cdot {f}_{a m p X} \cdot cos ( \frac{2 π}{T} t + φ ) ,$$

$$Δ {f}_{Y 1} ( t ) = {s}_{Y 1} \cdot {f}_{a m p Y} \cdot sin ( \frac{2 π}{T} t + φ ) ,$$

$$Δ {f}_{Y 2} ( t ) = {s}_{Y 2} \cdot {f}_{a m p Y} \cdot sin ( \frac{2 π}{T} t + φ ) ,$$

respectively, wherein s_{X1}, s_{X2}, s_{Y1}, s_{Y2} are selected from values +1 and −1, ƒ_{ampX} is a first multiplying factor determining a first radius R_{X} of the disc along the X axis, ƒ_{ampY} is a second multiplying factor determining a second radius R_{Y} of the disc along the Y axis, q is an arbitrary phase shift, and T is a time period required for scanning the disc, the value of which is between 0.25·T_{acc} and 1.6·T_{acc}, wherein T_{acc} is the filling time of the deflectors.

The filling time T_{acc} of the deflectors is T_{acc}=H/V, where in this case H is the diameter of the laser beam 17 entering the first acousto-optical deflector X1 downstream of the laser source 12 (which, as described above, is not the same as the laser beam 18 exiting the objective 14), since the diameter of the deflector X1 is greater than this, and V is the acoustic phase velocity in the AO crystal 40 of the acousto-optical deflector X1. It should be noted that in the present embodiment the four acousto-optical deflectors X1, X2, Y1, Y2 are of the same structure.

In the present embodiment, all four acousto-optical deflectors X1, X2, Y1, Y2 are optimized for the −1 diffraction order, therefore, in the arrangement shown in FIG. 1, the values s_{X1=-1} and s_{X2=1}, and s_{Y1}=−1 and s_{Y2}=1 are used, and the phase shift φ is chosen to be 0, which when substituted into the above equations results in the following Δƒ_{X1}(t), Δƒ_{X2}(t), Δƒ_{Y1}(t), Δƒ_{Y2}(t) frequency drive signal terms:

$$Δ {f}_{X 1} ( t ) = - {f}_{a m p X} \cdot cos ( \frac{2 π}{T} t ) ,$$

$$Δ {f}_{X 2} ( t ) = {f}_{a m p X} \cdot cos ( \frac{2 π}{T} t ) ,$$

$$Δ {f}_{Y 1} ( t ) = - {f}_{a m p Y} \cdot sin ( \frac{2 π}{T} t ) ,$$

$$Δ {f}_{Y 2} ( t ) = {f}_{a m p Y} \cdot sin ( \frac{2 π}{T} t ) .$$

It is well known to the person skilled in the art how to choose the terms ƒ_{0X1}(t), ƒ_{0X2}(t), ƒ_{0Y1}(t), ƒ_{0Y2}(t) such that in the absence of the terms Δƒ_{X1}(t), Δƒ_{X2}(t), Δƒ_{Y1}(t), Δƒ_{Y2}(t) these create a stationary focus spot at the centre of the disc having coordinates x, y, z (this is the random access point scanning mode, see e.g. WO2006/042130A2).

The frequency drive signal terms Δƒ_{X1}(t), Δƒ_{X2}(t), Δƒ_{Y1}(t), Δƒ_{Y2}(t) defining the circumference of the disc theoretically move the focal point 19 around the centre point having coordinates x, y, z along the circumference of the disc defined by the radii R_{X} és R_{Y}. If ƒ_{ampX}=ƒ_{ampY} then the disc is a circle (R_{X}=R_{Y}); if ƒ_{ampX}+ƒ_{ampY} then the disc is an ellipse (R_{X}≠R_{Y}).

When the period T of scanning the disk approaches the filling time T_{acc} of the deflectors X1, X2, Y1, Y2, satellite spots appear within the area of the disk next to the 19 focal point, the intensity of which is already high enough to create the simultaneous absorption of more than one photon necessary for the excitation of the fluorophores. In this way, the fluorophores located not only on the periphery of the disc, but also inside the disc can be simultaneously excited, thus the emitted fluorescence photons can be simultaneously detected from here as well. The advantage of the method according to the invention is that the inside of the disc does not need to be scanned separately, since the area of the disc is automatically scanned at the same time as the circumference of the disc is scanned. Since the satellite spots appear within the area of the disk (in the direction of the centre of the disk), the scanned area can be easily determined by choosing the appropriate multiplication factors ƒ_{ampX} and ƒ_{ampY}.

In the following, we will present the appearance of the satellite spots used for area scanning by way of the measurement results obtained with the microscope 10 according to FIG. 1.

For the series of measurements presented in FIGS. 2-11 show the dependence of the resulting scanning pattern on the period of scanning the disc (for short: scanning time). For these measurements, a circular disc was scanned for better illustration. The wavelength of the laser was 920 nm, the acoustic phase velocity was 705 m/s, the effective focal length of the objective 14 was 9 mm, the diameter of the beam entering the first deflector X1 was 15 mm, whereby the filling time was T_{acc}=21.3 μs. The multiplying factors were ƒ_{ampX}=ƒ_{ampY}=0.2123 MHz, which resulted in scanning a circle having a radius of approx. 5 μm. For the sake of simplicity in the measurements, the centre of the circle was at the point with coordinates x=y=z=0, which was achieved by selecting the value of the terms ƒ_{0X1}(t), ƒ_{0X2}(t), ƒ_{0Y1}(t), ƒ_{0Y2}(t) to correspond to the centre frequency of the frequency bands. The measurements were performed on submicron (in this case 170 nm) fluorescent polystyrene beads, which are the standard test objects of the two-photon microscope 10. The measurement results shown in the individual figures were obtained for different T scanning times (periods).

In the measurement according to FIG. 2, the scanning time of the circle was T=3·T_{acc}. The pattern is a circular ring on which small horizontal stripes appear due to the mechanical vibration of the sample. The thickness of the ring is approx. 0.5 μm in accordance with the resolution of the microscope.

In the measurement according to FIG. 3, the scanning time of the circle was T=2·T_{acc}. The pattern is similar to the previous one, basically a ring can be seen without any substantial artifacts.

In the measurement according to FIG. 4, the scanning time of the circle was T=1.8·T_{acc}. Here, the ring becomes less sharp, but the intensity of the satellite spots is still too small to cause any significant two-photon effect.

In the measurement according to FIG. 5, the scanning time of the circle was T=1.6·T_{acc}. At this scanning speed, an internal “order” begins to appear (however, it is very faint, so it is not clearly visible in the black-and-white image), in this case significant two-photon absorption occurs inside of the circular ring, and the emitted fluorescence photons are also detected from within the circle by the detectors 30.

In the measurement according to FIG. 6, the scanning time of the circle was T=1.4·T_{acc}. It can be seen that the former, well-defined circular ring begins to transform into a square standing on one of its vertices, and extra “orders” appear inside the circle. More and more fluorescent information comes from the area inside the circular ring.

In the measurement according to FIG. 7, the scanning time of the circle was T=T_{acc}. As the period time T of scanning the circle reaches the filling time T_{acc}, the centre of the circle becomes illuminated as a result of the increasing number of satellite spots, and clearly visible knots appear along the circumference of the circle.

In the measurement according to FIG. 8, the scanning time of the circle was T=0.75·T_{acc}. Here, the intensity of the focal spot scanning the circumference of the circle decreases, while the intensity of the satellite spots appearing around the centre of the circle increases, as a result, the area around the centre of the sample becomes the brightest.

In the measurement according to FIG. 9, the scanning time of the circle was T=0.5·T_{acc}. By further increasing the scanning speed, the knots within the circular ring become more and more defined, so less light reaches the intermediate, “smeared” part between the knots, but still, approximately the entire area of the circle is still illuminated.

In the measurement according to FIG. 10, the scanning time of the circle was T=0.25·T_{acc}. At this speed, the centre appears darker again, and the knots have transformed into a plurality of distinct dots forming a dot grid, but these dots still illuminate the area of the circular disk.

In the measurement according to FIG. 11, the scanning time of the circle was T=0.125·T_{acc}. In this case the frequency modulation responsible for drawing a circle is too fast to have a significant effect. Because of this, the centre is bright, the satellite spots have completely faded, and the focal spot appears undeflected at the location of the centre of the circle, which in this case is at the point determined by the coordinates x=y=z=0.

The scanning patterns shown above are also obtained if a point with arbitrary x, y, z coordinates is targeted by the terms ƒ_{0X1}(t), ƒ_{0X2}(t), ƒ_{0Y1}(t), ƒ_{0Y2}(t) in the traditional random access point scanning mode. In this case, this point will be the centre of the circle around which the circle drawing terms Δƒ_{X1}(t), Δƒ_{X2}(t), Δƒ_{Y1}(t), Δƒ_{Y2}(t) deflect the focal spot. By reducing the scanning time T of the circle, i.e. by increasing the scanning speed, similar patterns can be observed around the centre having coordinates x, y, z. If ƒ_{ampX}+ƒ_{ampY}, then the pattern is an ellipse instead of a circle, the minor and major diameters of which have the same proportion with respect to each other as the proportion of the two multiplication factors ƒ_{ampX}, ƒ_{ampY}.

If the frequency of the signal driving the deflectors is changed by Δf, the angle of the diffracted beam changes by

$$ΔΘ = \frac{λ}{V} \cdot Δ f$$

wherein λ is the wavelength of the laser beam and V is the acoustic phase velocity in the acousto-optic crystal. As a result of this, the displacement of the focal spot in the focal plane of the objective 14 having an effective focal length F_{obj} (assuming that the absolute value of the effective lateral magnification of intermediate optics, e.g. relays is 1) changes by:

$$Δ x = {F}_{obj} \cdot ΔΘ = {F}_{obj} \cdot \frac{λ}{V} \cdot Δ f$$

In the case of disk scanning, e.g. deflectors X1 and X2 deflect the same amount in absolute value, and these add up (because the sign of the modulating term is opposite, but there is also a relay of −1 magnification between the deflectors X1 and X2), therefore writing fₐₘₚ in place of Δf and multiplying the displacement by 2, we get the expected radius of the circle:

$$R = 2 {F}_{obj} \cdot \frac{λ}{V} \cdot {f}_{amp}$$

For example, in case of the parameters applied in FIGS. 1-11, λ=920 nm, V=705 m/s, ƒₐₘₚ=0.2123 MHz, F_{obj}=9 mm, the radius of the scanned circle is R=4.98 μm.

In the case of an ellipse, the above formulas yield different radii along the X and Y axes.

It is noted that as the focal spot moves around the circle (ellipse) faster and faster, and as the satellite spots fill the interior of the disc more and more, this radius size becomes more and more “nominal”.

When scanning larger disks with a radius of e.g. 10-30 μm, the RF power that determines the diffraction efficiency of the deflectors X1, X2, Y1, Y2 must be increased, on the one hand, so that the loss of intensity due to the scanning of the larger circle can be compensated, and on the other hand, because in order to scan a circle with the larger diameter the beam has to be deflected to a greater extent by the first pair of deflectors, and the more greatly deflected beam is diffracted less by the second pair of deflectors (due to the finite acceptance angle of the deflectors).

The inventors found that the size of the scannable circle (or ellipse) is limited only by the RF power determining the diffraction efficiency of the deflectors X1, X2, Y1, Y2 in addition to the limitations imposed by the bandwidth and the acceptance angle of the deflectors X1, X2, Y1, Y2 (which also limit the field of view).

FIGS. 12a-12c show the displacement of the scanned disk along the Z axis, i.e. a case where the disk (and its centre) does not lie in the focal plane. It is noted that the focal plane is always a plane which is parallel to the X-Y plane, and it is preferred to choose the coordinate system so that focal plane coincides with the X-Y plane.

For the sake of simplicity, these measurements also relate to scanning a circle, the centres of which was at points having coordinates in the form of x=y=0 and z=0.

The following measurements were also performed on submicron beads, and the following parameters: ƒ_{ampX}=ƒ_{ampY}=ƒₐₘₚ=0.2 MHz, the scanning period was T=T_{acc}, the laser wavelength was 920 nm, the beam diameter was 15 mm.

According to the measurement shown in FIG. 12a the z coordinate was z=50 μm (wherein the origin of the coordinate system was located in the focal plane). FIG. 12b shows a measurement wherein z=100 μm, FIG. 12c shows a measurement wherein z=150 μm.

In order to shift the centre of the circle along the Z axis more and more, it is necessary to create greater and greater beam deflection in the individual deflectors, as is well known in the random access point scanning mode. Because of this, the deflected beam is incident on the deflectors X2, Y2 at an angle different from the optimal angle, and therefore the diffraction efficiency decreases. Since the increasingly larger shift of the centre along the Z axis results in a decrease of the effective aperture and thus in a decrease of the beam intensity, the inside of the circle is less illuminated, while the focal depth increases. On the other hand, as the deflection along the Z axis is increased, the effective time window decreases in which there is still significant excitation, since the deflectors X2, Y2 receive the incident beam at an angle close to the optimum for a shorter and shorter period of time, and thus an increasingly larger slice of the circle becomes dark. It can be observed that at z=50 μm this effect is not disturbing at all, but at z=100 μm the upper quarter of the circle is dark, and at z=150 μm half of the circle is dark. This effect can be eliminated such that if the centre of the disk is more than 50 μm from the focal plane of the objective, then the disk is scanned in several cycles by scanning different portions of the disk's circumference in each cycle during a middle time window within the cycle time of the given cycle. This can be achieved by shifting the phase of the cosine or sine modulation, in order to start scanning the circle (or ellipse) in each cycle in a rotated position relative to each other, so that the dark part always falls somewhere else, in this way the entire circle can be scanned in several cycles. The cycles are preferably the same as the cycle time of the AO deflectors. For example, assuming a beam diameter of 15 mm, the typical AO deflector cycle time is around 20-30 μsec, but depending on the application, it is also possible to work with longer cycle times.

It is noted that in practice this method results in much faster scanning of a disk than the prior art methods, since in case of a shift of +/−150 μm along the Z axis, only two AO deflector cycle times are needed to scan a disc having a diameter of approx. 10-20 μm within a region of 300 μm thickness, which would require 10 to 20 or more cycles even with the prior art drift scanning technology.

The same consideration applies to scanning an ellipse shifted along the Z axis.

When shifting the centre of the disk parallel to the X-Y plane, no such phenomenon was experienced.

From the point of view of practical applications, the method according to the invention offers a good solution, for example, for the simultaneous stimulation of a cell soma (that is, for scanning the soma). Instead of a cell soma, of course, other small biological object (ideally a biological object with a diameter of less than 20 μm) can also be scanned, possibly together with its surroundings (ideally, the biological object with its surroundings does not exceed a region of 20 μm in diameter). The latter may be needed, for example, due to motion artifacts, as described in patent application WO 2018/042214 A2 and in “Fast 3D Imaging of Spine, Dendritic, and Neuronal Assemblies in Behaving Animals” (Szalay et al., 2016, Neuron 92, 723-738).

With the method according to the invention, a large number of spatially scattered measurement regions (regions of interest) with a diameter of no more than 20 μm can be scanned extremely quickly, almost simultaneously, since each measurement region can be scanned during one AO cycle. Therefore, scanning of n (n>1, even n>5 or n>10, but preferably n<100) number of regions can be scanned within n times the AO cycle time within a distance of 50 μm from the focal plane of the objective. The scanning of measurement regions lying at a distance of 50 to 150 μm from the focal plane of the objective can each be scanned separately in a maximum of two AO cycles. Even at greater distances, only a few AO cycles are required to scan each measurement range. Given that the AO cycle time is typically approx. 30 μsec in case of a typical beam diameter of 15 mm, therefore an area of 20 μm×20 μm can be scanned in 1-2 cycle times, which is 30-60 μsec, depending on the distance measured from the focal plane of the objective. Up to 10 measurement regions can be scanned in a few 100 μsec. In contrast, with state-of-the-art mini drifts, scanning a single 20 μm×20 μm area takes approx. 20×30 μsec=600 μsec, as explained in connection with the state of the art.

Another possible use, for example in case of in vivo measurements, is to scan a dendrite spike in such a way that a disk covering the dendrite spike is scanned, in this way it can be ensured that if the live sample (e.g. animal) moves during scanning, the dendrite spike will still fall within the scanned disk. For example, this can be achieved by scanning a disk (preferably a circular disk) with a diameter of approx. 5 μm.

It will be apparent to those skilled in the art that various modifications are conceivable to the above disclosed embodiments without departing from the scope of protection determined by the appended claims.

1. Method of scanning an area with a multi-photon laser scanning microscope comprising at least one laser source and a focusing lens system defining an optical Z axis, an optical beam path is provided between the at least one laser source and the focusing lens system, the microscope further comprising first and second acousto-optical deflectors arranged in the optical beam path for deflecting a laser beam exiting the focusing lens system in an X-Z plane defined by the optical Z axis and an X axis perpendicular to the optical Z axis, and third and fourth acousto-optical deflectors arranged in the optical beam path for deflecting the laser beam exiting the focusing lens system in an Y-Z plane defined by the optical Z axis and an Y axis perpendicular to the optical Z axis and the X axis, characterised by scanning a disk lying in a plane perpendicular to an X-Y plane defined by the X axis and the Y axis by guiding the laser beam along the optical beam path from the laser source to the focusing lens system while providing frequency drive signal functions ƒ_{X1}(t), ƒ_{X2}(t), ƒ_{Y1}(t), ƒ_{Y2}(t) to the first, second, third and fourth acousto-optical deflectors defined as
$${f}_{X 1} ( t ) = {f}_{0 X 1} ( t ) + Δ {f}_{X 1} ( t )$$
$${f}_{X 2} ( t ) = {f}_{0 X 2} ( t ) + Δ {f}_{X 2} ( t )$$
$${f}_{Y 1} ( t ) = {f}_{0 Y 1} ( t ) + Δ {f}_{Y 1} ( t )$$
$${f}_{Y 2} ( t ) = {f}_{0 Y 2} ( t ) + Δ {f}_{Y 2} ( t )$$
respectively, wherein ƒ_{0X1}(t), ƒ_{0X2}(t), ƒ_{0Y1}(t), ƒ_{0Y2}(t) are frequency drive signal terms for focusing the laser beam in random access point scanning mode to a centre of the disk, the centre having coordinates x, y, z, and Δƒ_{X1}(t), Δƒ_{X2}(t), Δƒ_{Y1}(t), Δƒ_{Y2}(t) are frequency drive signal terms determining a periphery of the disc and being defined as
$$Δ {f}_{X 1} ( t ) = {s}_{X 1} \cdot {f}_{ampX} \cdot cos ( \frac{2 π}{T} t + φ ) ,$$
$$Δ {f}_{X 2} ( t ) = {s}_{X 2} \cdot {f}_{ampX} \cdot cos ( \frac{2 π}{T} t + φ ) ,$$
$$Δ {f}_{Y 1} ( t ) = {s}_{Y 1} \cdot {f}_{ampX} \cdot sin ( \frac{2 π}{T} t + φ ) ,$$
$$Δ {f}_{Y 2} ( t ) = {s}_{Y 2} \cdot {f}_{ampY} \cdot sin ( \frac{2 π}{T} t + φ ) ,$$
wherein s_{X1}, s_{X2}, s_{Y1}, s_{Y2} are selected from values +1 and −1, ƒ_{ampX} is a first multiplying factor determining a first radius R_{X} of the disc along the X axis, ƒ_{ampY} is a second multiplying factor determining a second radius R_{Y} of the disc along the Y axis, φ is an arbitrary phase shift, and T is a time period required for scanning the disc, and selecting a value of the period T such as to fall between 0.25·T_{acc} and 1.6·T_{acc}, wherein T_{acc} is a filling time of the deflectors.

2. The method according to claim 1, characterised by selecting the period T such that its value is between 0.5·T_{acc} and 1.5·T_{acc}, preferably between 0.75·T_{acc} and 1.25·T_{acc}.

3. The method according to claim 1, characterised in that the disk is a circle or an ellipse.

4. The method according to claim 3, characterised in that both the radius R_{X} and the radius R_{Y} are between 2 μm and 20 μm, preferably between 5 μm and 10 μm.

5. The method according to claim 3, characterised by selecting a value of the multiplying factor ƒ_{ampX} so that the radius R_{X} has a first value, and selecting the value of the multiplying factor ƒ_{ampY} so that the radius R_{Y} has a second value.

6. The method according to claim 5, characterised in that the radius R_{X} and the radius R_{Y} have the same value.

7. The method according to claim 1, characterised in that the centre of the disk is at a distance of more than 50 μm from a focal plane of the objective, and the disk is scanned in several cycles by scanning different portions of the disk's circumference in each cycle during a middle time window within a cycle time of the given cycle.

8. The method according to claim 1, characterised in that the laser scanning microscope is a two-photon microscope.

9. Use of the method according to claim 1 for scanning a region of interest of biological samples, characterised by selecting the centre of the disc having coordinates x, y, z so as to coincide with a centre of the region of interest, and selecting a value of the multiplying factor ƒ_{ampX} so that a value of the radius R_{X} is equal to a half of a diameter of the region of interest along the X axis, and selecting a value of the multiplying factor ƒ_{ampY} so that a value of the radius R_{Y} is equal to a half of a diameter of the region of interest along the Y axis.

10. The method according to claim 9, characterised in that several regions of interest are scanned consecutively, the centres of which lie in different planes parallel to the X-Y plane.

11. A multi-photon laser scanning microscope comprising at least one laser source and a focusing lens system defining an optical Z axis, an optical beam path is provided between the at least one laser source and the focusing lens system, the microscope further comprising first and second acousto-optical deflectors arranged in the optical beam path for deflecting a laser beam exiting the focusing lens system in an X-Z plane defined by the optical Z axis and an X axis perpendicular to the optical Z axis, and third and fourth acousto-optical deflectors arranged in the optical beam path for deflecting the laser beam exiting the focusing lens system in an Y-Z plane defined by the optical Z axis and an Y axis perpendicular to the optical Z axis and the X axis, characterised by comprising a drive system configured to scan a disk lying in a plane perpendicular to an X-Y plane defined by the X axis and the Y axis and configured to generate frequency drive signal functions ƒ_{X1}(t), ƒ_{X2}(t), ƒ_{Y1}(t), ƒ_{Y2}(t) for the first, second, third and fourth acousto-optical deflectors defined by
$${f}_{X 1} ( t ) = {f}_{0 X 1} ( t ) + Δ {f}_{X 1} ( t )$$
$${f}_{X 2} ( t ) = {f}_{0 X 2} ( t ) + Δ {f}_{X 2} ( t )$$
$${f}_{Y 1} ( t ) = {f}_{0 Y 1} ( t ) + Δ {f}_{Y 1} ( t )$$
$${f}_{Y 2} ( t ) = {f}_{0 Y 2} ( t ) + Δ {f}_{Y 2} ( t )$$
respectively, wherein ƒ_{0X1}(t), ƒ_{0X2}(t), ƒ_{0Y1}(t), ƒ_{0Y2}(t) are frequency drive signal terms for focusing the laser beam in random access point scanning mode to a centre of the disk, the centre having coordinates x, y, z, and Δƒ_{X1}(t), Δƒ_{X2}(t), Δƒ_{Y1}(t), Δƒ_{Y2}(t) are frequency drive signal terms determining a periphery of the disc and being defined as
$$Δ {f}_{X 1} ( t ) = {s}_{X 1} \cdot {f}_{ampX} \cdot cos ( \frac{2 π}{T} t + φ ) ,$$
$$Δ {f}_{X 2} ( t ) = {s}_{X 2} \cdot {f}_{ampX} \cdot cos ( \frac{2 π}{T} t + φ ) ,$$
$$Δ {f}_{Y 1} ( t ) = {s}_{Y 1} \cdot {f}_{ampY} \cdot sin ( \frac{2 π}{T} t + φ ) ,$$
$$Δ {f}_{Y 2} ( t ) = {s}_{Y 2} \cdot {f}_{ampY} \cdot sin ( \frac{2 π}{T} t + φ ) ,$$
wherein s_{X1}, s_{X2}, s_{Y1}, s_{Y2} are selected from values +1 and −1, ƒ_{ampX} is a first multiplying factor determining a first radius R_{X} of the disc along the X axis, ƒ_{ampY} is a second multiplying factor determining a second radius R_{Y} of the disc along the Y axis, φ is an arbitrary phase shift, and T is a time period required for scanning the disc having a value between 0.25·T_{acc} and 1.6·T_{acc}, wherein T_{acc} is a filling time of the deflectors.

12. The laser scanning microscope according to claim 11, characterised in that the value of the time period T is between 0.5·T_{acc} and 1.5·T_{acc}, preferably between 0.75·T_{acc} and 1.25·T_{acc}.

13. The laser scanning microscope according to claim 11, characterised in that the disk is a circle or an ellipse.

14. The laser scanning microscope according to claim 13, characterised in that both the radius R_{X} and the radius R_{Y} are between 2 μm and 20 μm, preferably between 5 μm and 10 μm.

15. The laser scanning microscope according to claim 13, characterised in that a value of the multiplying factor ƒ_{ampX} is selected so that the radius R_{Y} has a first value, and the value of the multiplying factor ƒ_{ampY} is selected so that the radius R_{Y} has a second value.

16. The laser scanning microscope according to claim 15, characterised in that the radius R_{X} and the radius R_{Y} have the same value.

17. The laser scanning microscope according to claim 11, characterised in that the laser scanning microscope is a two-photon microscope.
